(19) United States
(12) Patent Application Publication
(10) Pub. No.: US 2007/0295588 A1
(43) Pub. Date: Dec. 27, 2007

(54) Half-Mirror-Ornamented Key Sheet and Keytops

(76) Inventor: Yoshitaka Kamata, Niigata (JP)

Correspondence Address: WESTMAN CHAMPLIN & KELLY, P.A., SUITE 1400, 900 SECOND AVENUE SOUTH, MINNEAPOLIS, MN, 55402-3319, US

(21) Appl. No.: 11/661,061

(22) PCT Filed: Aug. 25, 2005
(86) PCT No.: PCT/JP05/15393

§ 371 Date: Feb. 22, 2007

(30) Foreign Application Priority Data
Aug. 25, 2004 (JP) 2004-244613
Nov. 8, 2004 (JP) 2004-323165

(51) Int. Cl. H01H 13/14

(52) U.S. Cl. 200/341

(57) ABSTRACT

A key sheet and a key top of novel design such that a character or a symbol cannot be recognized visually when not illuminated and can be recognized visually only when illuminated. In the key sheet comprising a key top for pressing a key and a key pad on which a plurality of key tops are placed in a matrix and which supports them integrally through transparent adhesive, the key top is composed of a transparent material, e.g. resin or glass, and provided with a metal thin film (half-silvered mirror) on the upper or lower surfaces. Consequently, a character or a symbol cannot be recognized visually when not illuminated and can be recognized visually only when illuminated.

### TECHNICAL FIELD

The present invention relates to a key sheet and keytops of a new design used for devices having keytops of a push-button input type, such as a mobile telephone, personal data assistant (PDA), and personal computer or the like. The present invention is configured so that the surface looks like metallic-tone, and the characters, symbols or the like on the surface are made invisible in a non-illuminated condition, and the characters, simbols or the like on the surface are made visible by the transmitting light from an illumination light in an illuminated condition.

### BACKGROUND ART

The foregoing key sheet is an assembly including a plurality of keytops (push buttons) and a sheet-like keypad. The key sheet is called an assembly because a plurality of the keytops are attached to the keypad by use of a transparent adhesive and both the keytops and the keypad can be integrally handled as a single assembly during the manufacture of devices.

In general technical fields other than the field of key sheets or keytops (push buttons) or the like, it is known that a metallic-tone appearance can be obtained by forming a metal film(s) on the surface by use of plating, vapor deposition or the like. However, when applying this method to the technical field of keytops (push buttons) and showing desired characters, symbols or the like on the surface as illuminated type, it has been absolutely necessary to cut the metal films into the shapes of characters, symbols or the like by lasing to form the reverse-printed characters, symbols or the like identifying the functions of each key.

In addition, it has been achievable only when applying to relatively thin metal films, such as using vapor deposition or sputtering, and it has not been achievable when using plating. Additionally, it lacks something for providing a design feature so innovative to attract users, and it will be limited within the standardized designs.

Patent References 1 and 2 listed below disclose an illuminated type key and a push-button switch, respectively. However it has not been disclosed or suggested to form a metal film(s) on the surface of the key and switch in these References.

Patent Reference 3 listed below discloses an invention concerned with a telephone having a liquid-crystal display (LCD) and push buttons ornamented into a metallic texture. However, these push buttons are not illuminated type. The object of this invention is to prevent static electricity from flowing into the LCD through the metal film, and electrically damaging or destroying the LCD when fingers charged with the static electricity touch the metal film of the push button. Therefore a transparent insulating film is provided on the metal film. For this reason, the information disclosed in this Reference does not have a direct relationship with the present invention relating to illuminated keys.
[Patent References 1] Japanese Laid-Open Patent Application Publication No. Hei 5-83347 (83347/1993)
[Patent References 2] Japanese Registered Utility Model Publication No. 3024123
[Patent References 3] Japanese Laid-Open Patent Application Publication No. Hei 7-245190 (245190/1995)

### DISCLOSURE OF THE INVENTION

### Problems to be Solved by the Invention

It is a first object of the present invention to provide the key sheet of a new design that is adapted to make characters, symbols or the like invisible in a non-illuminated condition, and make characters, symbols or the like visible only in an illuminated condition.

To achieve the above first object, the time-consuming process step to make up a screen-printing plate is required because the characters, symbols or the like are printed on the keytops by use of an ordinary coating material. It is a second object of the present invention to simplify a manufacturing process by making the above process step unnecessary.

### Means for Solving the Problems

According to the present invention, the above first object can be solved by implementing the step of providing a half-mirror metal film on an upper or lower surface of the keytop.

According to the present invention, the above second object can also be solved by implementing the steps of providing a first thin metal film on an upper or lower surface of the keytop, showing the characters, symbols or the like with partially cutting the thin metal film into the shapes of characters, symbols or the like (i.e., to form so-called reverse characters) by lasing, and providing a second thin metal film working as a half-mirror, on the upper surface of the keytop.

### EFFECTS OF THE INVENTION

According to the present invention, it is possible to obtain the key sheet of a new design that is adapted to make characters, symbols or the like invisible in a non-illuminated condition, and make characters, symbols or the like visible only in an illuminated condition.

In addition, the characters, symbols or the like become invisible in a non-illuminated condition because the characters, symbols or the like provided on the keytop are visually obstructed by the metallic-tone appearance of the second thin metal film, and the characters, symbols or the like are visible through the second thin metal film in an illuminated condition because the half-mirror effect of the second thin metal film allows the light through the reverse-character section thereon. Therefore the key sheet with a new ornamental effect can be obtained.

A further, specific advantageous effect is that an impression of high grade or high quality according to the metallic-tone appearance can be obtained compared to an ordinary and familiar key sheet of a conventional bottom-character-printed (negative or positive) structure just by forming a metal film on the keytop surface. In other words, it is possible to provide the products having the highly-consumer-attractive key sheet that can arouse the interest and buying inclination of consumers.

Additionally, it is only necessary to input data for characters, symbols or the like into a laser cutting machine to form characters, symbols or the like in the above-mentioned first thin metal film by laser irradiation. Therefore, it is possible to omit the time-consuming process step of making a screen-printing plate.

### BRIEF DESCRIPTION OF THE DRAWINGS

FIG. 1 is a view showing a mobile telephone having a key sheet of the present invention, (a) shows a non-illuminated key sheet state, and (b) shows an illuminated key sheet state;

FIG. 2 is a view showing the keypad formed in a first embodiment of the present invention, (a) is a plan view of the keypad, and (b) is a bottom view thereof;

FIG. 3 is an enlarged view showing a key sheet for use in the first embodiment of the present invention, (a) is a partial side view showing the key sheet in an enlarged form, and (b) is an enlarged sectional view of section A-A;

FIG. 4 is an enlarged partial view showing a layered structure of a keytop in the first embodiment of the present invention;

FIG. 5 is an enlarged partial view showing a layered structure of a keytop in a second embodiment of the present invention;

FIG. 6 is an enlarged partial view showing a layered structure of a keytop in a third embodiment of the present invention;

FIG. 7 is an enlarged partial view showing a layered structure of a keytop in a fourth embodiment of the present invention;

FIG. 8 is an enlarged partial view showing a layered structure of a keytop in a fifth embodiment of the present invention;

FIG. 9 is a view showing a construction of the layers formed in a keytop of a sixth embodiment of the present invention;

FIG. 10 is a sectional view showing a keypad-coupled state of a keytop in a seventh embodiment of the present invention; and

FIG. 11 is a sectional view showing an eighth embodiment of the present invention.

### BEST MODE FOR CARRYING OUT THE INVENTION

The present invention is, of course, applicable to a single keytop. The invention, however, is usually used as a sheet-like keypad that integrally supports a plurality of keytops. That is because the present invention brings about great, advantageous effects for reducing both process steps and assembly times during assembly of the devices having the keytops since a plurality of the keytops are attached to the surface of the keypad by use of a transparent adhesive and since both the keytops and the keypad can be integrally handled as a single assembly during the manufacture of devices.

### Embodiment 1

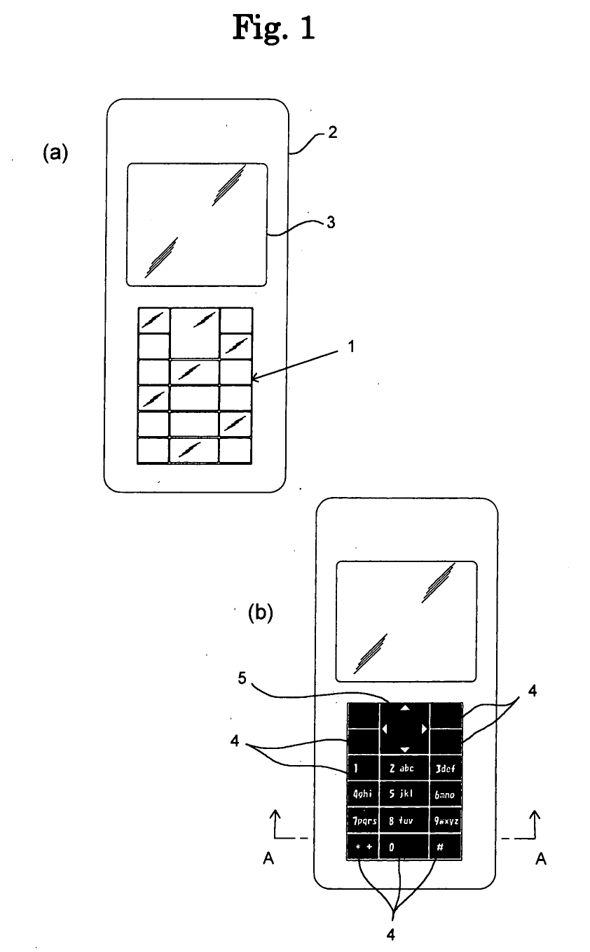

FIG. 1(a) is a view showing an example of a mobile telephone 2 incorporating a key sheet 1 of the present invention, and this view shows how the key sheet 1 looks when it is not illuminated. The mobile telephone 2, except for a liquid-crystal display screen 3 and a case portion, i.e., the entire surface of the key sheet 1, looks shiny in a metalic color such as lustrous silver or the like, and the characters, symbols or the like on the surface of each key are invisible.

FIG. 1(b) shows an illuminated state of the same key sheet 1 of FIG. 1, and numerals 0-9, alphabetic characters “a”-“z”, or symbols “*”, “+”, “#” marked in a reverse form on each of keytops 4 (state, in which characters or the like are visible with light being emitted from the surface of each key top 4 in the shape of characters or the like). The largest key is a “four-direction key with an enter key 5”. The key 5 has the enter key in the center and an arrow-marked (Δ) four-direction indicator key around the enter key.

In FIG. 1(b) showing the illuminated state of the key sheet, portions other than the reverse characters on each keytop 4 look black even though they are not colored in black. That is a graphic representation of the optical illusion effect resulting from visual contrast between the reverse character portions that emit light, and the other portions not emitting light.

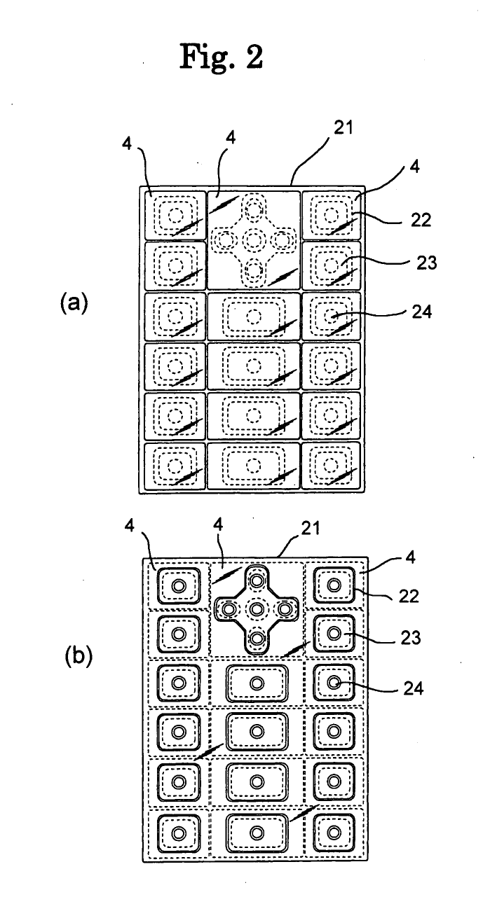

FIG. 2(a) is a plan view of the key sheet 1, showing the keytops 4 arranged in a matrix format on a reinforcing plate 21. The reinforcing plate 21 is a plate-like structure made of polycarbonate (PC) resin or stainless steel (SUS), having a large number of through-holes. The largest broken-line frames defined by broken lines represent a large number of the through-holes formed in the reinforcing plate 21, and the portions defined by broken-line frames 23 smaller than the above-mentioned frames represent keypads 23 inserted into the through-holes 22. The broken-line circle shown in the center of each keypad represents a pushing element 24 (a compressing projection for transmitting keytop operation to a contact point).

FIG. 2(b) is a rear view of the reinforcing plate 21. The portions shown in a broken-line in FIG. 2(a) are shown in a solid-line in FIG. 2(b), and the portions shown in a solid-line in FIG. 2(a) are shown in a broken-line in FIG. 2(b).

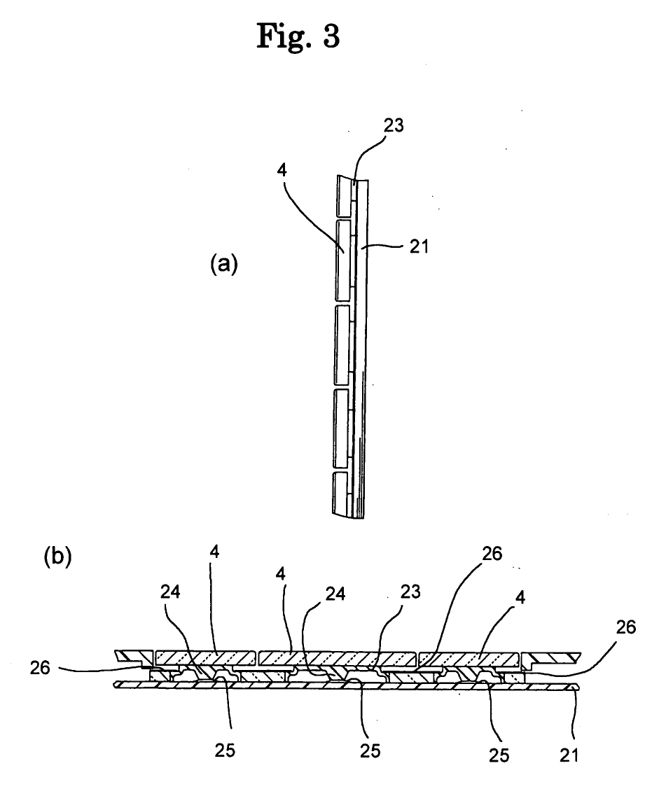

FIG. 3(a) is an enlarged partial view of the key sheet 1 of the present invention, and FIG. 3(b) is an enlarged sectional view of section A-A. In FIG. 3(b), the dome-shaped portion positioned below the pushing element 24 is a switch (a contact point) 25 that operates when the pushing element 24 moves downward. The portions shown with a slightly thick horizontal line, under adjacent keytops 4 are mask sheets 26 in FIG. 3(b). A function of the mask sheets 26 is to prevent light from leaking upward from a clearance between adjacent keytops 4 in an illuminated state.

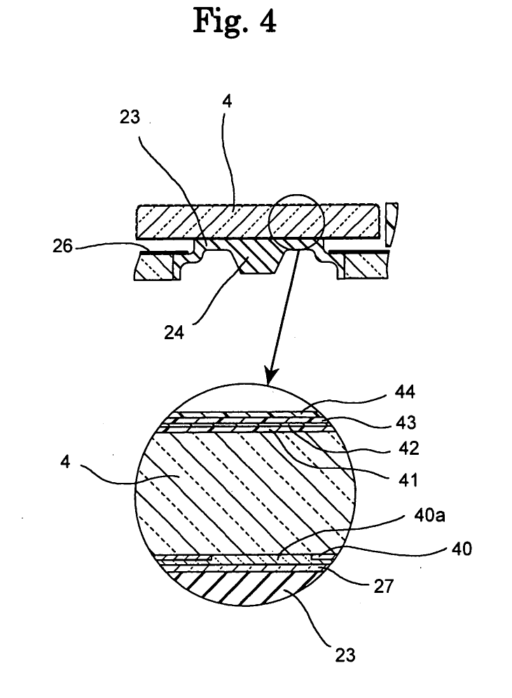

FIG. 4 is a partial, enlarged sectional view of a keytop 4, and is also a view showing a coated state of the keytop 4 by further enlarging an encircled portion thereof. A film of the keytop 4 is formed of a transparent material, for example, a resin, a glass, or the like.

The film-forming process for the keytop 4 begins with turning it upside down and forming a negative character (reverse character) print layer 40 on the backside of the keytop. After that, a colorless or colored translucent print layer 40a is formed on the print layer 40, and such reverse section 40a is filled with this material. In the next place, the upside-down state is released and the surface of the keytop 4 is provided with an undercoat 41, on which a thin metal film (half mirror) 42 is then overlaid.

Examples of the kind of metal usable for the thin metal film (half mirror) 42 include: aluminum, titanium, chromium, iron, nickel, copper, zinc, zirconium, molybdenum, silver, indium, tin, tungsten, platinum, or gold . . . alone or an alloy of these metals, or the like.

The thin metal film (half mirror) 42 is formed by, for example, physical vapor deposition (PVD) such as vacuum vapor deposition, molecular beam evaporation (MBE), ion plating, ion beam evaporation, conventional sputtering, magnetron sputtering, ion beam sputtering, or ECR sputtering. Hereinafter, the method of forming the thin metal film 42 is called “half-mirror ornamenting.”

One example of thickness of the thin metal film 42 is 5 nm to 35 nm, and substantially it may be 10 to 30 nm when aluminum is used for the material.

A middle coat 43 is further overlaid on the thin metal film 42, and finally an overcoat or topcoat 44 is provided thereon. Coloring in various colors is possible by making the overcoat 44 on the half-mirror ornamental layer colored transparent/translucent, instead of colorless.

Examples of the kind of material usable for each coated layer are shown below. For example, an acrylic binder is selectable for the undercoat 41, a vinyl-containing binder, for the middle coat 43, and an acrylic binder, for the topcoat 44.

Each coated layer can have a thickness of, for example, 8-10 μm for the undercoat 41, 8-10 μm for the middle coat 43, and 18-20 μm for the topcoat 44.

The keypad 23 is molded into a sheet-like form and has the pushing element (a compressing projection) 24 for compressing a contact point, and a keytop-fixing section. The keypad 23 is integrally molded with silicone rubber or a thermoplastic elastomer. Alternatively, a sheet-like member that totally works as one keypad, may be formed with silicone rubber or a thermoplastic elastomer, without using the reinforcing plate 21.

Other examples of alternative methods for embodying the present invention without using any of the above film-forming methods are shown below. That is to say, one alternative method would be providing a metallic foil entirely onto the bottom of the keytop by hot-stamping, and provide a full-surface coating or full-surface (solid) printing onto the metallic foil, then removing a part of the film by means of laser marking to form reverse characters (symbols or graphics). A further alternative method would be forming a character-print layer (positive characters, symbols or the like) on the metallic foil and then further forming a colorless or colored translucent printing layer (solid-print layer) on the character print layer so that a light will be emitted from portions other than the characters, simbols or the like in an illuminated condition.

Reverse characters (negative characters) or a positive character print layer 40 is formed at the backside of the keytop 4. For reverse characters, a colored layer may be overlaid for coloring.

The half-mirror (ornamental layer) 42 would be formed together with the character print layer 40 or the like only on one surface, either a front or a back surface of the keytop, instead of forming the half-mirror (an ornamental layer) 42 directly formed on the surface of the keytop 4.

A film on which a half mirror (ornamental layer) has been formed using a method such as in-mold drawing can be used as a further alternative method, instead of forming the half-mirror (ornamental layer) 42 directly on the surface of the keytop 4.

An embodiment in which the topcoat 44 needs to be coated on the surface of the keytop 4 will be explained below. The metal film generated by sputtering or an evaporation process is very thin. Depending on the kind of utilized metal, the metal film could also suffer deterioration by corrosion or discoloration due to oxidation or other chemical changes. In the case of a soft metal such as aluminum, in particular, the film is likely to be damaged or peeled off when it is abraded or scratched.

Therefore it is preferable to provide a process called topcoating (or overcoating) 44 to protect a sputtering-formed film or an evaporation-formed film from external chemical/physical actions. It is preferable to use a transparent coating material such as so-called clear lacquer for the topcoating 44. As is the case with the base coat 41, a topcoat 44 is formed by the same coating and curing process steps as those of ordinary coating/painting. A method of creating gold-colored appearance by providing yellow topcoat onto a silver-colored aluminum sputtering film is known as an example of application of the top coating process as mentioned above.

The thin metal film having the layers which have been formed from the foregoing materials, by use of the foregoing methods, and with the foregoing coated-layer thicknesses, has a half-mirror effect because of the clearances existing between metal particles which are layered thinly.

### Embodiment 2

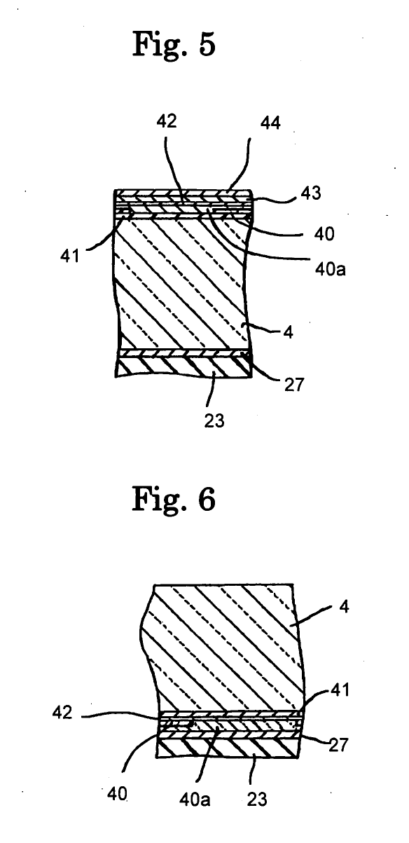

The embodiment of the present invention, shown in FIG. 1, can take various modifications or variations. The example shown in FIG. 5 is a second embodiment having all layers provided on an upper surface of the keytop 4. At first, a white undercoated layer 41 (solid color layer) is formed on the upper surface of the keytop 4, and then a reverse character (negative character) print layer 40 is formed on the undercoated layer 41 by screen printing.

When a colorless or colored translucent print layer 40a is further formed on the keytop, the reverse section 40a is filled with this material. A thin metal film (half mirror) 42 is formed on the translucent print layer 40a, and then a middle coat 43 and a topcoat 44 are sequentially formed to protect the surface. Additionally, a lower surface of a keytop 4 is bonded directly onto a keypad 23 via a transparent adhesive layer 27.

### Embodiment 3

The embodiment shown as an example in FIG. 6 is a third embodiment having all layers provided on a lower surface of a keytop 4. At first, the keytop 4 has been turned upside down and an undercoated layer 41 is provided on the lower surface, and then a reverse character print layer 40 is formed via a thin metal film (half mirror) 42. In the next place, a colorless or colored translucent print layer 40a is attached in the way that the reverse character portion is filled with the translucent material. The under surface of the keytop 4 is further bonded onto a keypad 23 via a transparent adhesive layer 27.

In this example, no layers are formed on the upper surface of the keytop 4. That is to say, there is no need to form a topcoat that undertakes surface protection of the keytop 4.

### Embodiment 4

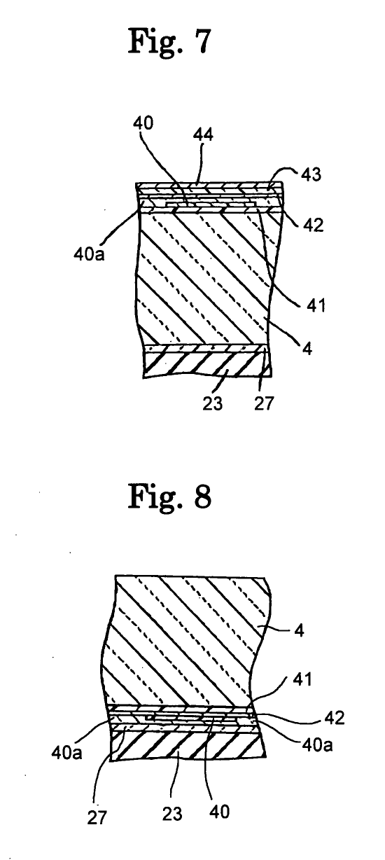

An embodiment shown as an example in FIG. 7 is a fourth embodiment having all layers provided on an upper surface of a keytop 4 in an example of the character (positive) printing. At first, an undercoated layer 41 is formed on the upper surface of the keytop 4, then a character (positive) print layer 40 is formed on the undercoated layer 41, and a colorless or colored translucent print layer 40a is attached to an upper and peripheral portion of the character print layer 40. Then a thin metal film 42 is attached to the layer 40a directly or via the undercoat, and a middle coated-layer 43 is formed, and finally, a topcoat 44 is provided to protect the surface.

No layers are formed on a lower face of the keytop 4 (only a keypad 23 is bonded via a transparent adhesive layer 27 ex post facto). In the case of this Embodiment, when it is illuminated, the entire key top is illuminated in a color of a colored translucent print layer, in which the characters or the like are displayed in a dark color.

### Embodiment 5

An embodiment shown as an example in FIG. 8 is a fifth embodiment having all layers provided on a lower surface of a keytop 4 in an example of the character (positive) printing. At first, the keytop 4 has been turned upside down, and an undercoated layer 41 is provided on the lower surface, then a thin metal film 42 is formed on the undercoat 41, and a character print (positive) layer 40 is formed. In the next place, a colorless or colored translucent print layer 40a is attached in the way that a peripheral part of the character portion is filled with the translucent material. Then the keytop 4 is bonded onto a keypad 23 via a transparent adhesive layer 27.

In this example, no layers are formed on the lower surface of the keytop 4. That is to say, there is no need to form a topcoat 44 that undertakes surface protection of the keytop 4. The characters or the like are also visible almost in the same manner as in the above Embodiment 4 when being illuminated in the case of this Embodiment.

### Embodiment 6

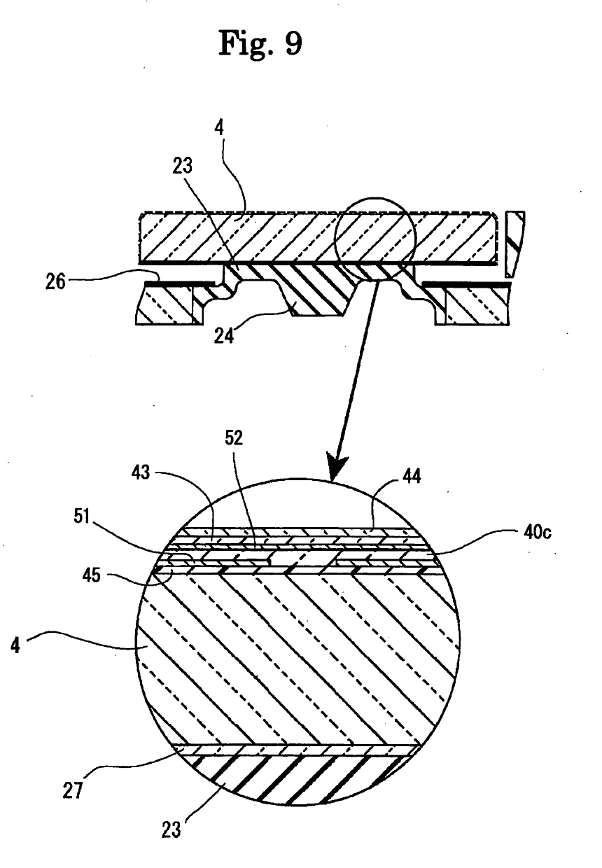

Process steps are simplified in the sixth to eighth embodiments as shown below (see FIGS. 9 to 11). More specifically, according to these processes, it is not necessary to conduct the time-consuming process step of “making a screen-printing plate” which is traditionally needed to print characters, symbols or the like on keytops using a normal coating material as shown in the first embodiment as illustrated in FIGS. 1 to 4.

FIG. 9 is a partial, enlarged view of a key sheet 1, showing a layered structure of a keytop 4 formed of a transparent material such as a resin or-a glass by further enlarging the. section encircled in this view.

A film-forming process for the keytop 4 is started by forming a first thin metal film 51 on the surface of the keytop 4, followed by irradiating the first thin metal film 51 with laser light (YVO4, YAG, CO2, or the like), and then forming the negative character (reverse character) patterns that represent desired characters, symbols or the like. After that, a colorless or colored translucent resin layer 40c is formed on the negative characters, and a part of the resin layer 40c flows and filled into the place where the characters or the like of the first thin metal film 51 are removed.

Furthermore, a second thin metal film 52 to operate as a half mirror is formed in the way of overlapping on the resin layer 40c, as required, and then a middle coat 43 and a topcoat 44 are further formed on the second thin metal film 52 in order to protect the metal film 52 and adjust a color tone thereof. The adjustment is conducted, for example, to make the middle coat 43 orange-colored and give gold-colored appearance to silver-colored thin metal film 52.

Examples of the kinds of metals usable for the first thin metal film 51 and the second thin metal film 52 include: aluminum, titanium, chromium, iron, nickel, copper, zinc, zirconium, molybdenum, silver, indium, tin, tungsten, platinum, or gold . . . alone or an alloy of these metals.

Also, examples of the physical vapor deposition (PVD) methods usable to form the thin metal films 51, 52, include vacuum vapor deposition, molecular beam evaporation (MBE), ion plating, ion beam evaporation, conventional sputtering, magnetron sputtering, ion beam sputtering, or ECR sputtering.

The first thin metal film 51 can have a thickness thin enough to transmit no light. For example, the film thickness can be 40 to 500 nm for an aluminum film, and substantially the thickness may be 50 to 100 nm. The second thin metal film 41 is adjusted in film thickness so as to work as a half mirror. In the case of aluminum, for instance, the film thickness may be 5 to 40 nm, and substantially it may be 10 to 30 nm. The film thickness of the first thin metal film 51 may also be the same as that of the second thin metal film 52. In the case of aluminum, for instance, the film thickness may be 5 to 40 nm, and substantially it may be 10 to 30 nm. In addition, an undercoat 45 may be provided on the surface of the keytop 4 before the film is formed thereon in order to make the first thin metal film 51 easy to form.

### Embodiment 7

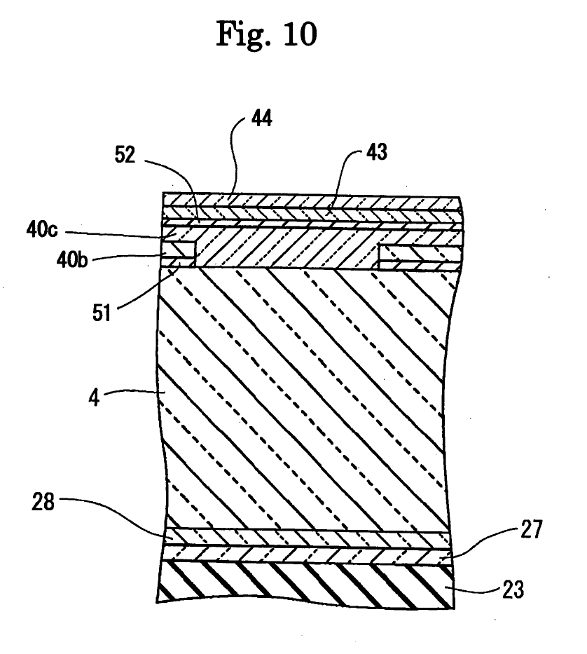

FIG. 10 is a sectional view of the above-formed keytop 4 bonded onto a keypad 23 via a colored translucent print layer (it may be omitted) and a transparent adhesive layer 27 formed on the backside surface of the keytop 4 and having a coloring effect for the light emitted from a light source.

### Embodiment 8

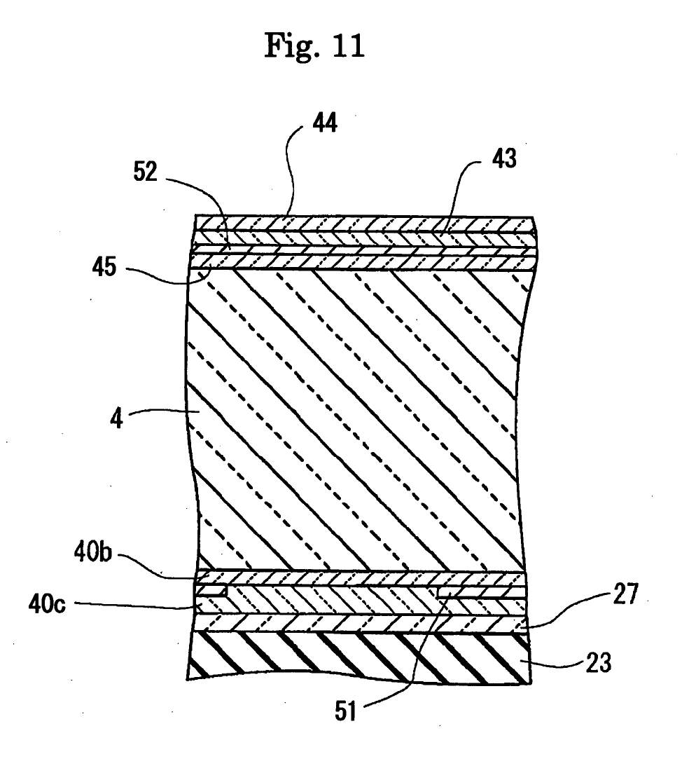

A further embodiment of the present invention is an example in which, as shown in FIG. 11, a second thin metal film 52 to work as a half mirror is provided on an upper surface of a keytop and a first thin metal film 51 for forming characters or symbols or the like is provided on a lower surface of the keytop. In this example, an undercoat 45 is provided between the upper surface of the keytop and the second thin metal film 52, and a transparent resin layer 40b is interposed between the lower surface of the keytop and the first thin metal film 51. Other structural aspects are basically the same as those of above Embodiment 6.

### INDUSTRIAL APPLICABILITY

The present invention is the key sheet and sheet of a new design used for devices having keytops of a push-button input type, such as a mobile telephone, personal data assistant (PDA), and personal computer or the like, wherein the invention is configured so that the surface looks like metallic-tone and the characters, symbols or the like on the surface are not visible in a non-illuminated condition, and the characters, symbols or the like on the surface are visible by the transmitting light from an illumination light in an illuminated condition.

For these reasons, the present invention is applicable in the telecommunications equipment industry and related industries.

### EXPLANATION OF REFERENCE NUMBER

1 a keysheet
2 a mobile phone
3 a display screen
4 a keytop
5 a four-direction key with an enter key
21 a reinforcing plate
22 a through-hole
23 a keypad
24 a pressing element
25 a switch (a contact point)
26 a mask sheet
27 a transparent adhesive
28 a colored translucent print layer
40 a reverse character (negative) print layer
40a a translucent print layer
40b a transparent resin layer

1. A key sheet comprising:
keytops for keying; and
a keypad with said keytops rested thereon in a plurality of positions in a matrix form, said keypad using a transparent adhesive to integrally support said plurality of keytops; wherein each of said keytops is made of a transparent material such as a resin, a glass or the like, and a thin metal film that works as a half mirror is formed on a lower surface or an upper surface of said keytop, so that characters, symbols or the like are made visible only in an illuminated state even though characters, symbols or the like are made invisible in a non-illuminated state.

2. The key sheet according to claim 1, wherein a print layer for characters and symbols is formed on a bottom surface of said keytop, and a thin metal film that works as a half mirror is formed on a top and side surfaces of said keytop.

3. The key sheet according to claim 1, wherein a thin metal film that works as a half mirror on the same plane as a top surface or a lower surface of said keytop, and a print layer of characters and symbols are provided in a stacked manner.

4. An illuminated keytop with characters and symbols marked thereon, wherein a thin metal film that works as a half mirror is formed on an upper surface or a lower surface made of a transparent material such as a resin, a glass or the like, so that characters, symbols or the like are made visible only in an illuminated state even though characters, symbols or the like are made invisible in a non-illuminated state.

5. The keytop according to claim 4, wherein a print layer of characters and symbols is formed on a bottom surface of said keytop, and a thin metal film that works as a half mirror is formed on a top and side surfaces of said keytop.

6. The keytop according to claim 5, wherein a thin metal film that works as a half mirror on the same plane as a top surface or a lower surface of said keytop, and a print layer of characters and symbols are provided in a stacked manner.

7. A key sheet comprising a keytop made of a transparent material such as a resin, a glass or the like, and a keypad formed of a sheet-shaped translucent elastic structure such a rubber, said key sheet adhered to said keytop rested thereon in a plurality of positions in a matrix form with a transparent adhesive; wherein:
a first thin metal film is formed on an upper surface or a lower surface of each of said keytops, then the thin metal film is partially cut into shapes of characters, symbols, or the like by laser irradiation for indication of the characters, symbols, or the like; and
the characters, symbols or the like are made invisible in a non-illuminated state, and the characters ,symbols or the like are made visible only in an illuminated state by forming a second thin metal film that works as a half mirror on the upper surface of said keytop.

8. The key sheet according to claim 7, wherein the first thin metal film is formed on the upper surface of said keytop, then a transparent resin-coated layer is formed for surface smoothing after the characters, symbols or the like have been marked, and the second thin metal film is overlaid on the resin-coated layer.

9. The key sheet according to claim 7, said first thin metal film is provided on the lower surface of said keytop.
